(19) United States
(12) Patent Application Publication
(10) Pub. No.: US 2012/0141888 A1
(43) Pub. Date: Jun. 7, 2012

(54) OXYGEN-CONSUMING ELECTRODE AND PROCESS FOR THE PRODUCTION THEREOF

(75) Inventors: Andreas Bulan, Langenfeld (DE); Jürgen Kintrup, Leverkusen (DE); Stefanie Eiden, Leverkusen (DE)

(73) Assignee: Bayer MaterialScience AG, Leverkusen (DE)

(21) Appl. No.: 13/307,059

(22) Filed: Nov. 30, 2011

(30) Foreign Application Priority Data
Dec. 3, 2010 (DE) 102010062421.7

(51) Int. Cl. H01M 8/22; B05D 3/00; H01M 8/08; C25B 11/04; H01M 4/88; C25B 11/06; B05D 5/12; H01M 4/90

(52) U.S. Cl. 429/405; 427/58; 429/501; 204/282

(57) ABSTRACT

The present invention relates to an oxygen-consuming electrode comprising at least one support element in the form of a sheet-like structure and a coating comprising a gas diffusion layer and a catalytically active component, wherein the oxygen-consuming electrode is additionally coated with a fluoropolymer which is soluble in solvents.

### CROSS REFERENCE TO RELATED APPLICATIONS

Priority is claimed to German Patent Application No. 10 2010 062 421.7, filed on Dec. 3, 2010 which is incorporated herein by reference, in its entirety, for all useful purposes.

### BACKGROUND OF THE INVENTION

The invention relates to an oxygen-consuming electrode, in particular for use in chloralkali electrolysis, having a new type of coating and also an electrolysis apparatus. The invention further relates to a process for producing the oxygen-consuming electrode and also its use in chloralkali electrolysis or fuel cell technology.

The invention proceeds from oxygen-consuming electrodes known per se which are configured as sheet-like gas diffusion electrodes and usually comprise an electrically conductive support and a gas diffusion layer having a catalytically active component.

Various proposals for operating the oxygen-consuming electrodes in electrolysis cells of industrial size are known in principle from the prior art. The basic idea is to replace the hydrogen-evolving cathode of the electrolysis (for example in chloralkali electrolysis) by the oxygen-consuming electrode (cathode). An overview of possible cell designs and solutions may be found in the publication by Moussallem et al “Chlor-Alkali Electrolysis with Oxygen Depolarized Cathodes: History, Present Status and Future Prospects”, J. Appl. Electrochem. 38 (2008) 1177-1194.

The oxygen-consuming electrode, hereinafter also referred to as OCE for short, has to meet a series of requirements in order to be able to be used in industrial electrolysers. Thus, the catalyst and all other materials used have to be chemically stable to sodium hydroxide solution having a concentration of about 32% by weight and to pure oxygen at a temperature of typically 80-90° C. A high measure of mechanical stability is likewise required for the electrodes to be able to be installed and operated in electrolysers having a size of usually more than 2 m² in area (industrial size). Further properties are: a high electrical conductivity, a low layer thickness, a high internal surface area and a high electrochemical activity of the electrocatalyst. Suitable hydrophobic and hydrophilic pores and an appropriate pore structure for the conduction of gas and electrolyte are likewise necessary, as is freedom from leaks so that gas space and liquid space remain separated from one another. The long-term stability and low production costs are further particular requirements which an industrially usable oxygen-consuming electrode has to meet.

Many compounds have been described as catalyst for the reduction of oxygen. However, only platinum and silver have attained practical importance as catalyst for the reduction of oxygen in alkaline solutions.

Platinum has a very high catalytic activity for the reduction of oxygen. Owing to the high costs of platinum, this is used exclusively in supported form. However, the stability of carbon-supported platinum electrodes in long-term operation is unsatisfactory, presumably because platinum also catalyzes the oxidation of the support material. In addition, carbon promotes the undesirable formation of H₂O₂.

Silver likewise has a high catalytic activity for the reduction of oxygen.

Although carbon-supported silver catalysts are more durable than the corresponding platinum catalysts, the long-term stability under the conditions in an oxygen-consuming electrode, especially when used for chloralkali electrolysis, is limited. Silver catalysts are therefore preferably used in unsupported form.

In the production of OCEs with an unsupported silver catalyst, the silver can at least partly be introduced in the form of silver oxides which are then reduced to metallic silver. The reduction is carried out either during start-up of the electrolysis, in which conditions for reduction of silver compounds prevail, or in a separate step by means of a preferably electrochemical route.

In the production of oxygen-consuming electrodes having unsupported silver catalysts, a distinction can in principle be made between dry and wet production processes.

In the dry processes, a mixture of catalysts and polymeric component is processed by means of a mixer which has fast-running beaters to give a mixture which is applied to the electrically conductive support element and pressed at room temperature. Such a process is described in EP 1728896 A2. The intermediate described in EP 1728896 consists of 3-15 parts of PTFE, 70-95 parts of silver oxide and 0-15 parts of silver metal powder.

In the wet production processes, an intermediate in the form of a paste or a suspension containing fine silver particles and a polymer component is used. Water is generally used as suspension medium, but it is also possible to use other liquids such as alcohols or mixtures thereof with water. Surface-active substances can be added in the production of the pastes or suspensions in order to increase their stability. The pastes are applied by means of screen printing or calendering to the support element, while the less viscous suspensions are usually sprayed onto the support element. Drying is followed by sintering at temperatures in the region of the melting point of the polymer. Here, the auxiliaries added, e.g. emulsifiers or thickeners, are removed. Such a process is described, for example, in US20060175195 A1. The ratio of PTFE to silver in the intermediate corresponds to the ratio customary in the dry process.

The OCE usually separates electrolyte and gas space and has an electrically conductive layer containing a catalyst, in or on which layer the electrochemical reaction takes place, e.g. the reduction of oxygen occurs at the three-phase boundary of electrolyte, catalyst and reactant gas. The boundary layer is generally held in the OCE by the surface tension of the electrolyte on the hydrophobic electrode material against the hydrostatic pressure of the electrolyte on the OCE. However, only a small pressure drop between gas side and liquid side is permissible. If the gas-side pressure is too high, the gas breaks through the OCE and the function of the OCE is destroyed in this region and the electrolysis process is interrupted. If, on the other hand, the liquid pressure is too high, the three-phase boundary is pushed out of the region comprising the catalyst in the OCE, which likewise interferes in the function of the OCE and when the pressure is increased further leads to liquid breakthrough of electrolyte into the gas space. In the case of a vertical electrode arrangement, as is necessary, for example, in the case of membrane electrolyses in order to be able to discharge the target product chlorine advantageously, this leads to a limitation to the construction height of the gas diffusion electrodes since otherwise gas pushes through at the OCE into the cathode space at the top and electrolyte pushes through into the gas space at the bottom. The industrially realizable construction height is therefore restricted to about 20-30 cm, which is insufficient for commercial membrane electrolysers since solutions for pressure compensation have to be found and implemented in technically complicated constructions.

DE 19622744 C1 describes an electrochemical half cell in which the gas space is divided into two or more superposed gas pockets into which or from which gas is fed or discharged via separate openings and the pressure on the electrolyte side of the electrode compared to the pressure on the gas side of the electrode is largely compensated by means of an opening in the gas pockets to the electrolyte. In this way, half cells having gas diffusion electrodes having a height of more than one meter can be realized. However, the construction is very complicated and cannot readily be installed in a conventional unit.

W00157290 A1 describes a half cell in which the liquid is conveyed via a percolator along the OCE. In this arrangement, no liquid column acts on the liquid side of the OCE and no pressure profile is built up over the construction height of the cell. However, the construction described in WO0157290A1 is very complicated. To ensure a uniform flow of alkali and uniform supply of catholyte to the OCE, a percolator, ion-exchange membrane and OCE have to be positioned and installed very precisely.

A further possible way of preventing disruptive gas and liquid breakthroughs through the OCE is to provide the OCE with a hydrophobic layer on the gas side. The hydrophobic layer is joined to the OCE by means of heat and pressure. Such OCEs are offered for sale by E-TEK under the name ESNS™. (See Frederico, Martinelli and Pinter in Modern Chlor-Alkali Technology, Volume 8″ Blackwell Science, Oxford).

However, these electrodes have the disadvantage that the hydrophobic layer displays poor adhesion to the OCE, so that cracks in the hydrophobic layer and even delamination in relatively long-term operation can easily occur during the electrolysis. These electrodes are therefore unsuitable for practical operation.

A further embodiment for achieving large construction heights is the “zero gap” arrangement. In this, the OCE lies directly on the ion-exchange membrane. This arrangement is usually also employed in fuel cell technology. The sodium hydroxide solution is here drained through the OCE to the gas side of the OCE and flows down there. A disadvantage is that the sodium hydroxide solution formed has to be conveyed through the OCE to the gas side, can block the pore system in the process and subsequently has to flow downward along the OCE. Due to the running down on the gas site of the OCE, a liquid film of sodium hydroxide solution can form and lead to blocking of the pores of the OCE, e.g. by accumulation of liquid in the pores or by crystallization of sodium hydroxide in the pores. Furthermore, the downflowing liquid film can hinder the mass transfer of oxygen (reactant gas). Furthermore, it has been found that very high sodium hydroxide concentrations are formed in the zero gap arrangement, and the ion-exchange membranes are not stable to these high concentrations in the long term (Lipp et al., J. Appl. Electrochem. 35 (2005) 1015—Los Alamos National Laboratory “Peroxide formation during chlor-alkali electrolysis with carbon-based ODC”).

It can thus be established that the previously known techniques for producing oxygen-consuming electrodes having a large construction height have great weaknesses in respect of implementability and stability in long-term operation.

### BRIEF DESCRIPTION OF THE INVENTION

It is an object of the present invention to provide an oxygen-consuming electrode, in particular for use in chloralkali electrolysis, which overcomes the above disadvantages and makes operation with large construction heights possible.

A specific object of the invention is to provide an OCE which avoids the disadvantages of the known constructions, can be installed without problems in existing membrane electrolysers and has a long operating life. A further object of the invention is to provide a simple means of improving or repairing existing oxygen-consuming electrodes which have developed leaks or whose performance is or has become unsatisfactory.

The object is achieved by the oxygen-consuming electrodes (OCEs) known per se being provided with a layer of a fluoropolymer, with the fluoropolymer layer being applied in the form of a solution in a solvent which can, for example, be removed by evaporation to the side of the OCE facing the gas side of the OCC.

An embodiment of the present invention provides an oxygen-consuming electrode comprising at least one support element in the form of a sheet-like structure and a coating comprising a gas diffusion layer and a catalytically active component, wherein the oxygen-consuming electrode is additionally coated with a fluoropolymer which is soluble in solvents.

Another embodiment of the present invention is the above oxygen-consuming electrode, wherein the oxygen-consuming electrode is coated on the side facing the gas with the fluoropolymer which is soluble in solvents.

Another embodiment of the present invention is the above oxygen-consuming electrode, wherein the fluoropolymer which is soluble in solvents comprises a copolymer which comprises perhalo-2,2-alkyl-1,3-dioxoles and at least one perfluorinated alkene compound as a monomer.

Another embodiment of the present invention is the above oxygen-consuming electrode, wherein the fluoropolymer which is soluble in solvents comprises a copolymer which comprises perfluoro-2,2-alkyl-1,3-dioxoles and at least one fluorinated olefin or fluorinated vinyl ether as a monomer.

Another embodiment of the present invention is the above oxygen-consuming electrode, wherein the fluoropolymer which is soluble in solvents comprises a copolymer which comprises perfluoro-2-methylene-4-methyl-1,3-dioxolane (PMD) or 2,2-bistrifluoromethyl-4,5-difluoro-1,3-dioxole (PDD) and at least one further,

Another embodiment of the present invention is the above oxygen-consuming electrode, wherein the fluoropolymer which is soluble in solvents comprises a copolymer which comprises 2,2-bistrifluoromethyl-4,5-difluoro-1,3-dioxole (PDD) and at least one further monomer selected from the group consisting of tetrafluoroethylene, hexafluoropropylene and perfluoro(butenyl vinyl ether).

Another embodiment of the present invention is the above oxygen-consuming electrode, wherein the solvent comprises a perfluorinated hydrocarbon compound or a perfluorinated derivatized hydrocarbon compound or a mixture of these compounds.

Another embodiment of the present invention is the above oxygen-consuming electrode, wherein the solvent comprises perfluoro(2-butyltetrahydrofuran).

Another embodiment of the present invention is the above oxygen-consuming electrode, wherein the electrode is coated with from 1 to 100 g of fluoropolymer per square meter of electrode area.

Another embodiment of the present invention is the above oxygen-consuming electrode, wherein the layer thickness of the fluoropolymer layer is from 0.01-100 μm.

Another embodiment of the present invention is the above oxygen-consuming electrode, wherein the catalytically active component comprises silver, silver (I) oxide or silver (II) oxide or mixtures of silver and silver oxide.

Another embodiment of the present invention is the above oxygen-consuming electrode, wherein the oxygen consuming electrode comprises a mixture comprising from 70 to 95% by weight of silver oxide as the catalytically active component, from 0-15% by weight of silver metal powder and 3-15% by weight of an insoluble fluorinated polymer.

Another embodiment of the present invention is the above oxygen-consuming electrode, wherein the gas diffusion layer comprises an insoluble fluorinated polymer.

Another embodiment of the present invention is the above oxygen-consuming electrode, wherein the support element has a flexible textile structure.

Another embodiment of the present invention is the above oxygen-consuming electrode, wherein the support element has a flexible textile structure that is made of metal threads.

Yet another embodiment of the present invention provides a process for producing the above oxygen-consuming electrode which comprises applying or spraying a solution of a fluoropolymer onto an oxygen-consuming electrode comprising at least one support element in the form of a sheet-like structure and a coating having a gas diffusion layer and a catalytically active component and subsequently removing the solvent by evaporation.

Yet another embodiment of the present invention provides an oxygen-consuming cathode in an electrolysis apparatus or an electrode in an alkaline fuel cell or an electrode in a metal/air battery comprising the above oxygen consuming electrode.

Yet another embodiment of the present invention provides an electrolysis apparatus, comprising the above oxygen-consuming electrode as an oxygen-consuming cathode.

Yet another embodiment of the present invention is a process for repairing, sealing or improving damaged or used oxygen-consuming electrodes comprising coating the oxygen-consuming electrode with a compound comprising fluoropolymers which are soluble in solvents.

Another embodiment of the present invention is the above process, wherein the fluoropolymer which are soluble in solvents comprises a copolymer made up of at least a compound selected from the group consisting of perhalo-2,2-alkyl-1,3-dioxoles, and at least one further monomer selected from the group consisting of perfluorinated alkene compounds.

### DETAILED DESCRIPTION OF THE INVENTION

As used herein, the singular terms “a” and “the” are synonymous and used interchangeably with “one or more” and “at least one,” unless the language and/or context cleary indicates otherwise. Accordingly, for example, reference to “a compound” herein or in the appended claims can refer to a single compound or more than one compound. Additionally, all numerical values, unless otherwise specifically noted, are understood to be modified by the word “about.”

An embodiment of the invention provides an oxygen-consuming electrode having at least one support in the form of a sheet-like structure and a coating comprising a gas diffusion layer and a catalytically active component, characterized in that the oxygen-consuming electrode is additionally coated with a fluoropolymer which is soluble in solvents.

Preference is given to a novel oxygen-consuming electrode, characterized in that the oxygen-consuming electrode is coated with a fluoropolymer which is soluble in solvents on its side facing the gas, in particular the oxygen-containing gas. The side of the OCE facing the gas forms, after installation, for example in an electrolyser, the wall of the gas space in which the oxygen-containing gas required for the electrolysis is present.

Conventional fluoropolymers such as polytetrafluoroethylene (PTFE) are not soluble in solvents. However, there are a number of fluorinated copolymers and even terpolymers having specific monomer building blocks which are soluble in a series of fluorinated solvents. These are preferably used. The specific monomers are first and foremost perhalo-2,2-alkyl-1,3-dioxoles, in particular 2,2-bistrifluoromethyl-4,5-difluoro-1,3-dioxole (PDD) and perfluoro-2-methylene-4-methyl-1,3-dioxolane (PMD). These monomers can be reacted with further fluorinated monomers such as tetrafluoroethylene, hexafluoropropylene, perfluoro(butenyl vinyl ether) and other fluorinated olefins or fluorinated vinyl ethers to form copolymers or terpolymers.

The glass transition temperature (TG) of the abovementioned PDD homopolymer is, for example, 335° C. The copolymers or terpolymers have lower glass transition temperatures, with the glass transition temperature generally decreasing as a function of the comonomer content. A comonomer of PDD and TFE having a PDD content of about 11.2 mol % has a TG of 57° C., a copolymer having a PDD content of about 56.9 mol % has a TG of 119° C. and a copolymer having a PDD content of about 90 mol % has a TG of 260° C. Preference is given to copolymers which are amorphous at the respective use temperatures.

The abovementioned copolymers and terpolymers containing perhalo-2,2-alkyl-1,3-dioxoles, in particular 2,2-bistrifluoromethyl-4,5-difluoro-1,3-dioxole (PDD) and perfluoro-2-methylene-4-methyl-1,3-dioxolane (PMD), are soluble in fluorinated solvents. Fluorinated solvents suitable as active dissolvers are, for example, perfluoro(2-butyltetrahydrofuran) (FC-75), N(C₄F₉)₃ (FC 40), perfluorinated hydrocarbons (FC-72) perfluoromethylcyclohexane, perfluorobenzenes and perfluorodecalin or mixtures thereof. The solubility is in each case determined by the composition of the polymer and the solvent. Solubilities of from 1% by weight to about 20% by weight have been described.

Preference is therefore given to a novel oxygen-consuming electrode, characterized in that the soluble fluoropolymer is a copolymer made up of at least one compound from the group consisting of perhalo-2,2-alkyl-1,3-dioxoles, in particular perfluoro-2,2-alkyl-1,3-dioxoles, preferably perfluoro-2-methylene-4-methyl-1,3-dioxolane (PMD or 2,2-bistrifluoromethyl-4,5-difluoro-1,3-dioxole (PDD), particularly preferably 2,2-bistrifluoromethyl-4,5-difluoro-1,3-dioxole (PDD), and at least one further monomer from the group consisting of perfluorinated alkene compounds, preferably fluorinated olefins or fluorinated vinyl ethers, in particular tetrafluoroethylene, hexafluoropropylene or perfluoro(butenyl vinyl ether).

The DuPont company offers specific copolymers of 2,2-bistrifluoromethyl-4,5-difluoro-1,3-dioxole (PDD) and tetrafluoroethylene for sale under the trade names Teflon AF 1600 (with a proportion of about 35% of TFE/65% of PDD and a TG of 160° C.) and Teflon Af 2400 (with a proportion of about 13% of TFE/87% of PDD and a TG of 240° C.) as resin and also as solution in perfluorinated solvents. A further copolymer, Teflon AF 1601, has the same monomer composition, glass transition temperature and a higher solubility than Teflon AF 1601, but the average molecular mass is lower. These selected soluble fluoropolymers are very particularly preferably used in the OCE.

Solutions of polymers in volatile solvents can be used in a manner known per se for coating of the OCE.

Coating with the abovementioned solutions of polymers in volatile solvents enable very thin coatings of 1 μm and thinner to be produced. However, greater layer thicknesses of 100 μm and more can also be produced. Alternate coating and evaporation of the solvent enables particularly high layer thicknesses to be produced. To achieve a homogeneous, crack- and stress-free layer, the solvent should preferably be removed by uniform evaporation of the solvent so that a uniform film without internal stresses is formed. Films and coatings composed of PDD-containing copolymers generally have a high gas permeability.

U.S. Pat. No. 5,326,839 describes in principle the use of PDD-containing copolymers for producing films and coatings.

It has now surprisingly been found that a durable coating of oxygen-consuming electrodes can be produced by means of solutions of fluoropolymers and that such a coating prevents, under the conditions in an electrolysis cell, undesirable flooding of the gas space with sodium hydroxide solution which can pass through the oxygen-consuming electrode and secondly prevents breakthrough of oxygen-containing gas through the oxygen-consuming electrode to the side of the sodium hydroxide even at relatively high pressures.

The OCEs provided for coating are produced by the conventional methods known per se, for example by the above-described wet or dry production processes.

Coating with the fluoropolymer is preferably carried out as last production step subsequent to the actual production of the OCE.

Thus, for example, an OCE produced by the process described in EP1728896A2 is coated uniformly with a fluoropolymer-containing solution on the side provided for gas contact. This can be effected by means of known coating technologies such as application by means of a brush, a roller, a doctor blade or another tool or by direct spraying or pouring of the fluoropolymer-containing solution onto the OCE.

Coating can be carried out in one operation or in a plurality of operations with intermediate removal of at least part of the solvent.

The amount of fluoropolymer applied is from 1 to 100 g, preferably 1-10 g, per square meter of electrode area.

Drying and curing of the applied solution is effected by techniques known from coating technology. Preference is given to drying in a convection dryer, with the evaporated solvent being recovered. Drying can be aided by additional heating, for example by means of infrared radiators.

The temperature and the air flow rate are selected so that, corresponding to the properties of the polymer and of the solvent, uniform film formation and solidification of the polymer without bubble or crack formation or deformation occurs.

The solvent, is, in particular, removed to a residual solvent content of <1% by weight, preferably <0.1% by weight, particularly preferably <0.05% by weight.

The layer thickness of the fluoropolymer layer composed of the soluble polymer after drying is preferably 0.01-100 μm, particularly preferably 0.1-10 μm.

As fluoropolymer, particular preference is given to using copolymers or terpolymers containing 2,2-bistrifluoromethyl-4,5-difluoro-1,3-dioxoles (PDD) and one or more further perfluorinated monomers such as polytetrafluoroethylene, polyhexafluoropropylene or polyvinyl fluoride, preferably tetrafluoroethylene. Corresponding particularly preferred polymers and their preparation are described, for example, in the patents U.S. Pat. No. 5,276,21, U.S. Pat. No. 5,310,838 and U.S. Pat. No. 5,354,910, U.S. Pat. No. 5,408,020.

Solvents used are perfluorinated hydrocarbons and perfluorinated derivatized hydrocarbons such as perfluoromethylcyclohexane, perfluorohexane, perfluorobenzene, perfluorodecalin, perfluorotrialkylamines such as perfluorotributylamine, perfluorinated polyethers and preferably perfluoro(2-butyltetrahydrofuran,), trade name Fluorinert® FC-75 from the 3M company.

The concentration of the polymer is selected so that, firstly, an ideally high concentration is achieved and, secondly, the solution can be readily processed by means of the coating process selected. The highest possible concentration of polymers in the solvent is sought. However, owing to the low solubility of the fluoropolymers, only solutions of a few grams per litre can be achieved.

It is in principle possible to provide all known oxygen-consuming electrodes with the coating according to the invention. In the case of electrodes in which the catalyst is added in the form of silver oxide during production, coating can be carried out before or after reduction of the silver oxide.

Coating with the soluble fluoropolymer is preferably employed for an oxygen-consuming electrode having silver, silver (I) oxide or silver (II) oxide or mixtures of silver and silver oxide as catalytically active component.

The novel oxygen-consuming electrode particularly preferably comprises mixtures containing, as catalytically active component, from 70 to 95% by weight of silver oxide, in particular silver (I) oxide, and 0-15% by weight of silver metal together with 3-15% by weight of an insoluble fluorinated polymer, in particular PTFE.

The novel oxygen-consuming electrode preferably contains insoluble fluorinated polymers, in particular polytetrafluoroethylene (PTFE), in its gas diffusion layer.

The support element can, in particular, be used in the form of a mesh, nonwoven, foam, woven fabric, braid, knitted, expanded metal or another permeable sheet-like structure. Preference is given to using a flexible textile structure, in particular one made of metal threads. Nickel and silver-plated nickel are particularly suitable as material for the support element.

A further preferred embodiment of the novel oxygen-consuming electrode is therefore characterized in that it has a flexible textile structure, in particular one made of metal threads, preferably composed of nickel or/and silver-plated nickel, as support element.

The novel oxygen-consuming electrode is preferably connected as cathode, and is operated, in particular, in an electrolysis cell for the electrolysis of alkali metal chlorides, preferably sodium chloride or potassium chloride, particularly preferably sodium chloride. The invention therefore also provides an electrolysis apparatus, in particular for chloralkali electrolysis, comprising a novel above-described oxygen-consuming electrode as oxygen-consuming cathode.

As an alternative, the oxygen-consuming electrode can preferably be connected as cathode in a fuel cell.

The invention further provides for the use of the novel oxygen-consuming electrode for the reduction of oxygen in an alkaline medium, in particular in an alkaline fuel cell, the use in drinking water treatment, for example for producing sodium hypochlorite, or the use in chloralkali electrolysis, in particular for the electrolysis of LiCl, KCl or NaCl.

The novel OCE is particularly preferably used in chloralkali electrolysis and here especially in the electrolysis of sodium chloride (NaCl).

In another aspect of the invention, it has surprisingly been found that an oxygen-consuming electrode known per se can be improved by use of fluoropolymers as described above which are soluble in solvents or can be improved in respect of its gas permeability or liquid permeability. The invention therefore also provides for the use of fluoropolymers which are soluble in solvents for repairing, sealing or improving damaged or used oxygen-consuming electrodes.

The soluble fluoropolymer for this purpose is preferably one of the abovementioned soluble fluoropolymers, in particular a copolymer made up of at least a compound from the group consisting of perhalo-2,2-alkyl-1,3-dioxoles, in particular perfluoro-2,2-alkyl-1,3-dioxoles, preferably perfluoro-2-methylene-4-methyl-1,3-dioxolane (PMD or 2,2-bistrifluoromethyl-4,5-difluoro-1,3-dioxole (PDD), particularly preferably 2,2-bistrifluoromethyl-4,5-difluoro-1,3-dioxole (PDD), and at least one further monomer selected from the group consisting of perfluorinated alkene compounds, preferably fluorinated olefins or fluorinated vinyl ethers, in particular tetrafluoroethylene, hexafluoropropylene or perfluoro(butenyl vinyl ether).

The invention is illustrated below by the examples which do not, however, constitute a restriction of the invention.

### EXAMPLE

3.5 kg of a powder mixture consisting of 7% by weight of PTFE powder, 88% by weight of silver (I) oxide and 5% by weight of silver powder type 331 from Ferro were mixed in a mixer from Eirich, model R02, equipped with a star agitator as mixing element at a speed of rotation of 6000 rpm in such a way that the temperature of the powder mixture did not exceed 55° C. This was achieved by the mixing operation being interrupted and the mixture being cooled. Mixing was carried out a total of six times. After mixing, the finished powder mixture was sieved through a sieve having a mesh opening of 1.0 mm

The sieved powder mixture was subsequently applied to a nickel wire mesh having a wire thickness of 0.2 mm and a mesh opening of 0.5 mm over an area of 19 cm×25 cm. Application was carried out with the aid of a 2 mm thick template, with the powder being applied by means of a sieve having a mesh opening of 1 mm. Excess powder which projected above the thickness of the template was removed by means of a scraper. After removal of the template, the support with the applied powder mixture was pressed by means of a roller press using a pressing force of 0.5 kN/cm. The prefabricated gas diffusion electrode was taken from the roller press.

The prefabricated gas diffusion electrode was sprayed on the side of the support element with 50 g of a 1% strength by weight solution of Teflon AF 1600 (copolymer of about 35% of TFE/65% of PDD, Tg 160° C., manufacturer: DuPont de Nemours) in FC-75 (perfluoro(2-butyl-tetrahydrofuran)) (loading corresponding to 9.5 g of solid/m²). The solvent was removed by heating at 60° C. for 2 hours in a drying oven.

The oxygen-consuming cathode produced in this way was used in the electrolysis of a sodium chloride solution in an electrolysis cell having a DuPONT N982WX ion-exchange membrane and a sodium hydroxide gap between oxygen-consuming cathode and membrane of 3 mm. The sodium hydroxide gap was completely flooded with sodium hydroxide solution. A gauge pressure of 120 mbar was set in the alkali gap and a gauge pressure of 10 mbar (relative to ambient pressure) of oxygen was set on the gas side of the oxygen-consuming cathode. The cell voltage at a current density of 4 kA/m², an electrolyte temperature of 90° C. and a sodium hydroxide concentration of 32% by weight was 2.1 V. The electrolysis was operated under these conditions for 100 days without undesirable breakthroughs of liquid or gas through the electrode occurring.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims

1. An oxygen-consuming electrode comprising at least one support element in the form of a sheet-like structure and a coating comprising a gas diffusion layer and a catalytically active component, wherein the oxygen-consuming electrode is additionally coated with a fluoropolymer which is soluble in solvents.

2. The oxygen-consuming electrode according to claim 1, wherein the oxygen-consuming electrode is coated on the side facing the gas with the fluoropolymer which is soluble in solvents.

3. The oxygen-consuming electrode according to claim 1, wherein the fluoropolymer which is soluble in solvents comprises a copolymer which comprises perhalo-2,2-alkyl-1,3-dioxoles and at least one perfluorinated alkene compound as a monomer.

4. The oxygen-consuming electrode according to claim 1, wherein the fluoropolymer which is soluble in solvents comprises a copolymer which comprises perfluoro-2,2-alkyl-1,3-dioxoles and at least one fluorinated olefin or fluorinated vinyl ether as a monomer.

5. The oxygen-consuming electrode according to claim 1, wherein the fluoropolymer which is soluble in solvents comprises a copolymer which comprises perfluoro-2-methylene-4-methyl-1,3-dioxolane (PMD) or 2,2-bistrifluoromethyl-4,5-difluoro-1,3-dioxole (PDD) and at least one further,

6. The oxygen-consuming electrode according to claim 1, wherein the fluoropolymer which is soluble in solvents comprises a copolymer which comprises 2,2-bistrifluoromethyl-4,5-difluoro-1,3-dioxole (PDD) and at least one further monomer selected from the group consisting of tetrafluoroethylene, hexafluoropropylene and perfluoro(butenyl vinyl ether).

7. The oxygen-consuming electrode according to claim 1, wherein the solvent comprises a perfluorinated hydrocarbon compound or a perfluorinated derivatized hydrocarbon compound or a mixture of these compounds.

8. The oxygen-consuming electrode according to claim 1, wherein the solvent comprises perfluoro(2-butyltetrahydrofuran).

9. The oxygen-consuming electrode according claim 1, wherein the electrode is coated with from 1 to 100 g of fluoropolymer per square meter of electrode area.

10. The oxygen-consuming electrode according to claim 1, wherein the layer thickness of the fluoropolymer layer is from 0.01-100 μm.

11. The oxygen-consuming electrode according to claim 1, wherein the catalytically active component comprises silver, silver (I) oxide or silver (II) oxide or mixtures of silver and silver oxide.

12. The oxygen-consuming electrode according to claim 1, wherein the oxygen consuming electrode comprises a mixture comprising from 70 to 95% by weight of silver oxide as the catalytically active component, from 0-15% by weight of silver metal powder and 3-15% by weight of an insoluble fluorinated polymer.

13. The oxygen-consuming electrode according to claim 1, wherein the gas diffusion layer comprises an insoluble fluorinated polymer.

14. The oxygen-consuming electrode according to claim 1, wherein the support element has a flexible textile structure.

15. The oxygen-consuming electrode according to claim 1, wherein the support element has a flexible textile structure that is made of metal threads.

16. A process for producing the oxygen-consuming cathode according to claim 1, which comprises applying or spraying a solution of a fluoropolymer onto an oxygen-consuming electrode comprising at least one support element in the form of a sheet-like structure and a coating having a gas diffusion layer and a catalytically active component and subsequently removing the solvent by evaporation.

17. An oxygen-consuming cathode in an electrolysis apparatus or an electrode in an alkaline fuel cell or an electrode in a metal/air battery comprising the oxygen consuming electrode according to claim 1.

18. An electrolysis apparatus, comprising the oxygen-consuming electrode according to claim 1 as an oxygen-consuming cathode.

19. A process for repairing, sealing or improving damaged or used oxygen-consuming electrodes comprising coating the oxygen-consuming electrode with a compound comprising fluoropolymers which are soluble in solvents.

20. The process according to claim 19, wherein the fluoropolymer which are soluble in solvents comprises a copolymer made up of at least a compound selected from the group consisting of perhalo-2,2-alkyl-1,3-dioxoles, and at least one further monomer selected from the group consisting of perfluorinated alkene compounds.
